(19) United States
(12) Patent Application Publication
(10) Pub. No.: US 2007/0117471 A1
(43) Pub. Date: May 24, 2007

(54) Battery connection systems and methods for use thereof

(75) Inventor: Kenneth M. Wagner, Delaware, OH (US)

Correspondence Address: LOCKE LIDDELL & SAPP LLP;ATTN. DOCKETING, 600 TRAVIS #3400, HOUSTON, TX, 77002, US

(73) Assignee: Liebert Corporation, Columbus, OH (US)

(21) Appl. No.: 11/601,393

(22) Filed: Nov. 17, 2006

Related U.S. Application Data
(60) Provisional application No. 60/597,268, filed on Nov. 19, 2005.

(51) Int. Cl. H01R 4/30

(52) U.S. Cl. 439/755

(57) ABSTRACT

A battery connection system includes a quick connect washer defining a central opening there through with first and second tabs extending from an outer periphery thereof for attaching one or more monitor cables to terminal ends of a battery. A fastening device extends through the central opening for fastening the quick connect washer to the battery terminal.

### CROSS REFERENCE TO RELATED APPLICATIONS

The present application claims benefit of and priority to U.S. Provisional Patent Application Ser. No. 60/597,268, filed Nov. 19, 2005, the contents of all of which are incorporated herein by reference.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

This disclosure relates generally to battery systems, and more particularly, to systems for connecting leads to battery terminals.

2. Description of the Related Art

To provide continuous power to a load in applications that require continuity of power, such as in hospitals and critical processes in both industrial and commercial settings, a UPS system is typically used to switch between a primary and one or more alternate power sources in the event of failure or instability of the primary source. FIG. 1 illustrates portions of a typical UPS system 10. As illustrated therein, one or more input power lines are connected to a UPS module 12, and one or more battery modules 14 are connected to the UPS module. Interconnection cables 16 connect the appropriate inputs of the USP module 12 to the battery terminals (not shown) on battery module 14. If the input power fails, the battery module 14 provides power to the UPS module 12. Such battery back-up power may be required when, for example, power from the AC power sources are performing outside of acceptable limits or fail completely.

Thus, it is essential that the battery systems perform as designed or serious consequences could result because of failure or partial failure of the battery system. Battery monitoring systems are often employed to monitor the battery modules and insure that viable back-up power exists. As also illustrated in FIG. 1, with typical battery monitoring systems, a battery monitoring system 18 has a cable 20 with leads connected to the terminals of the battery 14 to receive signals from the cells of the batteries 14. The monitoring system 18 interprets the signals received by the cable 20 to monitor the condition of the battery 14.

For ease of installing the monitoring system 18, quick-connect leads are used to connect the cable 20 to the battery terminals. FIG. 2 illustrates a typical, prior art battery connection assembly that uses a quick-connect system for connecting the sensing leads to the battery terminals. The battery 14 includes a terminal 30 to which the interconnect cable 16 attaches. An externally threaded terminal bolt 32 extends through central openings in a lock washer 34, a washer 36 and a terminal opening 38 of the interconnect cable 16. The terminal bolt 32 is received by an internally threaded opening 40 in the battery terminal 30 to secure the interconnect cable 16 to the battery terminal 30.

Additionally, as shown in FIG. 2, one or more tab washers 50a, 50b having tabs 52 may be attached to the terminal 30 by the terminal bolt 32. The number of tab washers 50 required depends on, for example, the number of connections to the monitoring system 18 required for each particular terminal 30. Some terminals require a single connection to the monitor system 18 and others require two connections, for example, a sense lead and a load lead may interconnect a battery terminal to the monitor system 18.

The requirement for either one or two tab washers 50 adds complexity to the installation of the UPS and monitoring system. Installers must keep track of which individual terminals require one tab washer and which terminals require two tab washers. Additionally, when two tab washers 50a and 50b are situated about the terminal bolt 32, the tab washers 50a, 50b can rotate such that the tabs 52 on the exterior of the two washers 50a and 50b become aligned or too close together to allow connection of quick connect leads to the terminal.

This application for patent discloses a quick-connect battery connection system, and methods for connecting a battery monitoring system to a battery using such a connection system.

### BRIEF SUMMARY OF THE INVENTION

In accordance with one embodiment of the present disclosure, a battery connection system is described, the connection system comprising a quick-connect washer defining a central opening therethrough and having first and second tabs extending from an outer periphery thereof for attaching to terminal ends of monitor cables, and a fastening device extending through the central opening for fastening the quick connect washer to a battery terminal. In accordance with further aspects of this embodiment, the battery connection system may further comprise an interconnect cable having a terminal end, such that the fastening device extends through an opening in the terminal end of the interconnect cable for fastening the interconnect cable to a battery terminal.

In accordance with another embodiment of the present disclosure, a method of connecting a battery monitoring system to a battery terminal is described, the method comprising the steps of fastening a quick connect washer having first and second tabs extending outwardly from an outer periphery thereof to a battery terminal, and connecting first and second cables of the battery monitoring system to the first and second tabs, respectively.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIG. 1 is a block diagram illustrating portions of an uninterruptible power supply (UPS) system.

FIG. 2 illustrates portions of a prior art battery connection system.

FIG. 3 illustrates an exemplary battery connection in accordance with teachings of the present disclosure.

FIG. 4 illustrates a further exemplary battery connection in accordance with teachings of the present disclosure.

FIG. 5 illustrates a detailed top view of an exemplary quick-connect washer in accordance with teachings of the present disclosure.

FIG. 6 illustrates a detailed top view of an alternative, exemplary quick-connect washer in accordance with the teachings of the present disclosure.

FIG. 7 illustrates a further exemplary, alternative quick-connect washer in accordance with teachings of the present disclosure.

FIG. 8 illustrates a side view of the quick-connect washer of FIG. 7.

FIG. 9 illustrates a top view of a further exemplary quick-connect washer in accordance with teachings of the present disclosure.

FIG. 10 illustrates a side view of the quick-connect washer of FIG. 9.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION

One or more illustrative embodiments incorporating the invention disclosed herein are presented below. Not all features of an actual implementation are described or shown in this application for the sake of clarity. It is understood that in the development of an actual embodiment incorporating the present invention, numerous implementation-specific decisions must be made to achieve the developer's goals, such as compliance with system-related, business-related, government-related and other constraints, which vary by implementation and from time to time. While a developer's efforts might be complex and time-consuming, such efforts would be, nevertheless, a routine undertaking for those of ordinary skill the art having benefit of this disclosure.

In general terms, Applicants have created quick-connect washer systems, or battery connection systems, for use in simply and rapidly connecting a battery to an appropriate system. Such a battery connection system may comprise a quick connect washer defining a central opening therethrough and having first and second tabs extending from an outer periphery thereof for attaching to terminal ends of monitor cables, and a fastening device extending through the central opening for fastening the quick connect washer to a battery terminal. Typically, the fastening device includes a bolt extending from the battery terminal and through the tab washer with a nut threaded onto the bolt to fasten the tab washer to the battery terminal. The battery connection system may further comprise an interconnect cable having a terminal end, the fastening device extending through an opening in the terminal end of the interconnect cable for fastening the interconnect cable to the battery terminal. The first and second tabs on the outer periphery of the washer of the system may be disposed to each other at an angle ranging from about 5° to about 180°, and/or may be bent at an angle away from the plane of the washer, the angle of bend ranging from about 5° to about 75°. Additionally, the quick connect washer may comprise a flat side generally opposite the first and second tabs.

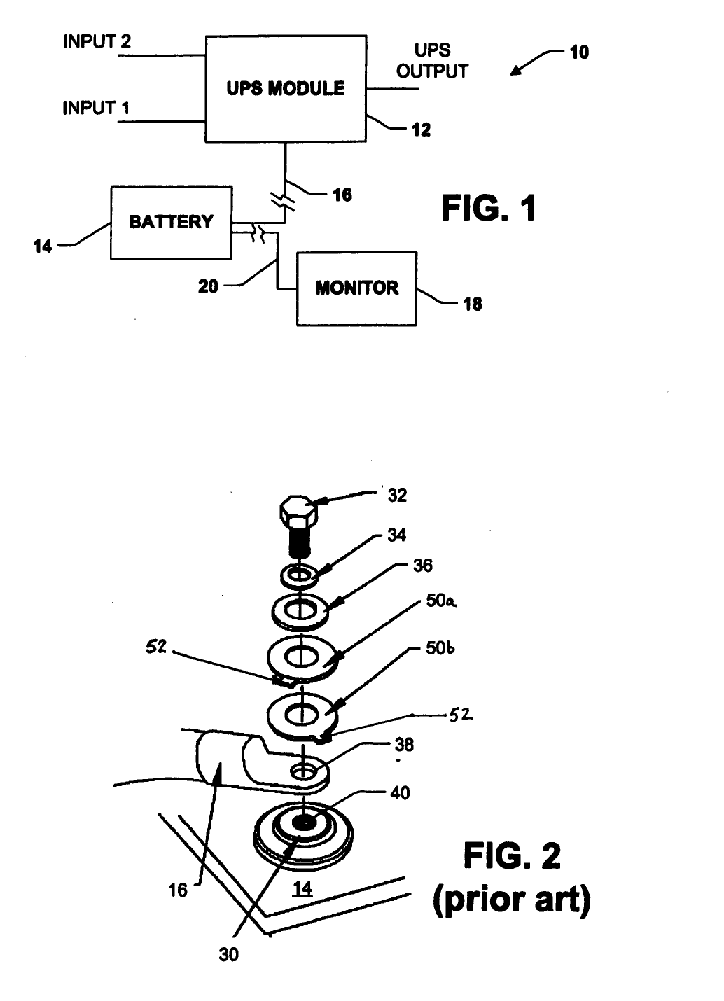

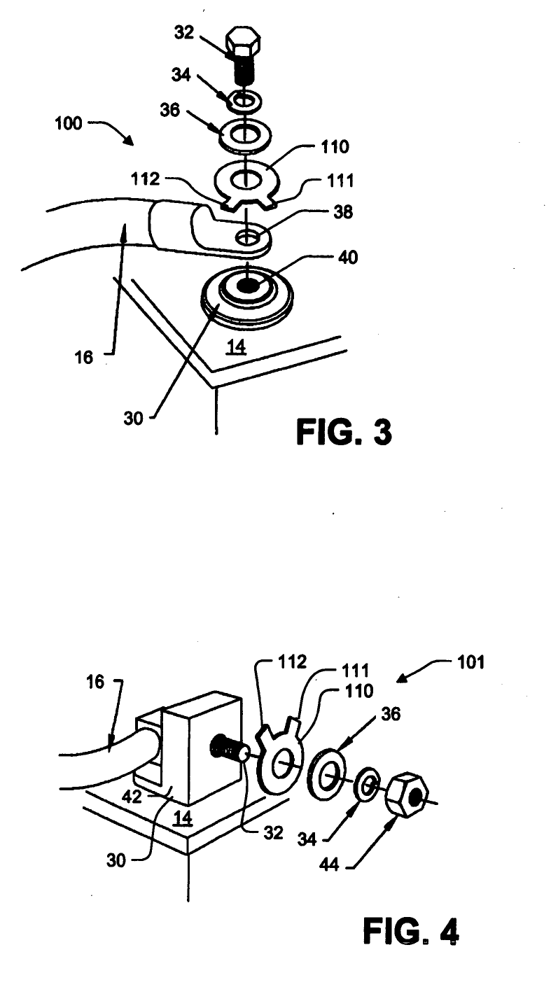

Turning now to the figures, FIG. 3 and FIG. 4 illustrate systems 100 and 101 for attaching cables to a battery terminal 30. These systems can provide, for example, a simple and rapid means to connect a battery 14 to a UPS module 12 and a battery monitoring system 18 as shown in FIG. 1. For simplicity, a single battery 14 is shown in FIG. 1, though typically several batteries may be connected to the UPS module 12 and the monitor 18. The systems 100,101 include a quick connect washer 110 that has first and second tabs 111 and 112 extending from the outer periphery of the washer 110. The tabs 111 and 112 allow for easy connection of one or two monitoring cables as may be required for the specific application. A fastening device such as a terminal bolt 32 extends through the central opening of the washer 110 to attach it to the battery terminal 30. As shown in FIG. 3, the terminal bolt 32 is received by a threaded opening 40 in the terminal 30. In FIG. 4, the battery terminal includes a flag post 42 and the terminal bolt 32 extends from the flag post 42, with a nut 44 threaded onto the bolt 32 to attach the quick connect washer 110 to the terminal.

As shown in the embodiment illustrated in FIG. 3, the terminal bolt 32 further extends through an opening 38 in the terminal end of the interconnect cable 16 to fasten it to the battery terminal 30. Additional fastening hardware, such as a lock washer 34 and flat washer 36 may be further provided, as in the illustrated exemplary embodiments shown, in order to more securely fasten the interconnect cable 16 and quick connect washer 110 to the battery terminal 30.

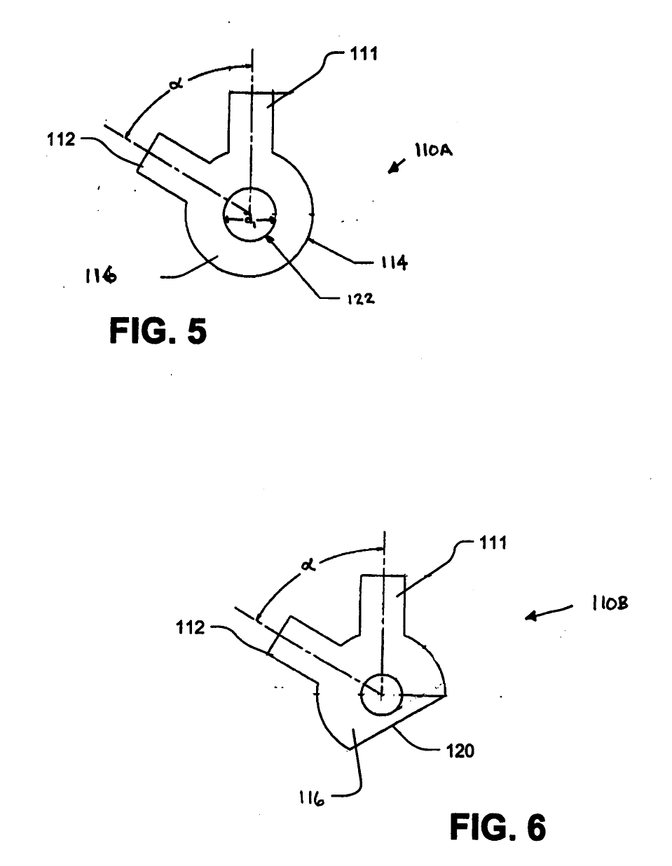

FIG. 5 and FIG. 6 illustrate details of exemplary quick connect washers 110A and 110B. In FIG. 5, the body of the washer 110A is shown to be generally annular with the tabs 111, 112 extending from the outer periphery 114 of the washer 110, and generally in the same plane as the top surface 116 of the washer. In the aspect of the disclosure shown in FIG. 6, a portion of the outer periphery of the washer 110B defines a flat side 120 generally opposite the tabs 111, 112, and perpendicular to top surface 116 of the washer. The flat side 120 may be included to help prevent the quick connect washer 110B from rotating about the terminal bolt 32, thereby keeping the tabs 111,112 in the desired position for attachment of the monitor cables. Similar to FIG. 5, the aspect of the disclosure illustrated in FIG. 6 has tabs 111 and 112 located in the same plane as the top surface 116 of the washer. In both FIG. 5 and FIG. 6, tabs 111 and 112 extend outward from the periphery 114 of the washer 110, and are oriented at an angle α relative to each other, the angle α ranging from about 5° to about 180°, and more preferably from about 5° to about 120°. Suitable values for the orientation angle α described herein include, but are not limited to, about 10°, about 15°, about 20°, about 25°, about 30°, about 35°, about 40°, about 45°, about 50°, about 55°, about 60°, about 65°, about 70°, about 75°, about 80°, about 85°, about 90°, about 95°, about 100°, about 105°, about 110°, about 115°, and about 120°, as well as values falling within any two values in this range, e.g., from about 15° to about 45°. In accordance with one aspect of the present disclosure, the orientation angle α is preferably about 60°.

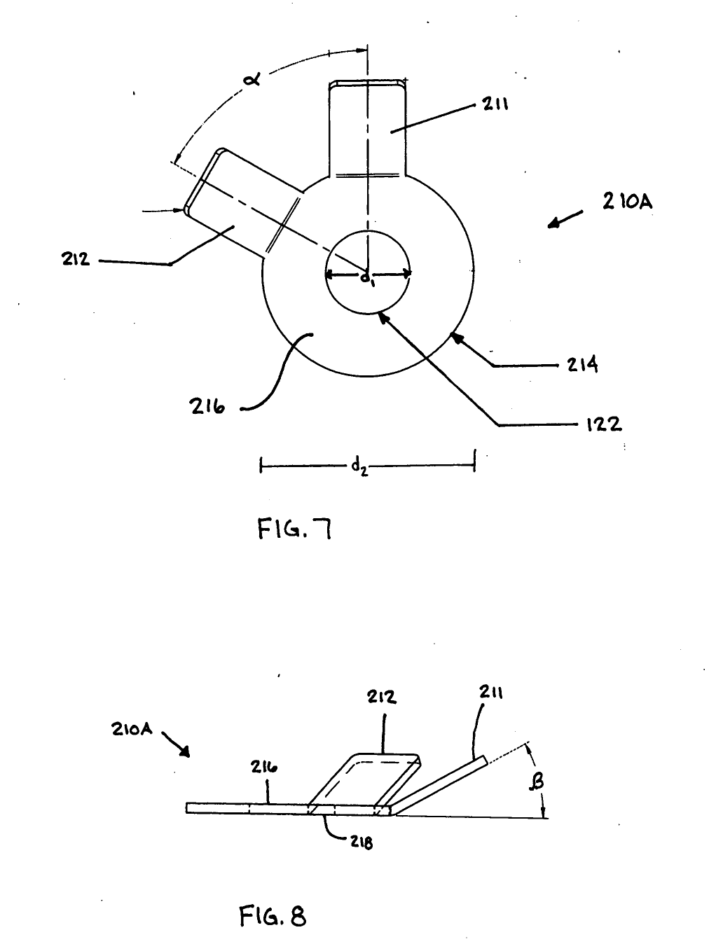

Turning to FIGS. 7 and 8, a quick-connect washer 210A in accordance with further aspects of the present disclosure is illustrated. As described with regard to quick-connect connect washer 110A above, the embodiments shown in FIGS. 7 and 8 also include a circular central opening 122, through which the terminal bolt 32 may extend. Quick-connect washer 210A has a body that is generally annular in shape, with the tabs 211 and 212 extending from the outer periphery 214 of the washer 210A. Similar to the aspect shown in FIG. 5 and FIG. 6, tabs 211 and 212 are oriented at an angle α relative to each other, the angle α ranging from about 5° to about 180°, more preferably from about 5° to about 120°, and even more preferably from about 10° to about 60°. In accordance with one aspect of the present disclosure, the tabs 211 and 212 are oriented at an angle α of about 30°. Tabs 211 and 212 are also upwardly offset from the plane defined by the top surface 216 of the washer 210A. This is shown more clearly in the side profile view of FIG. 8, wherein tabs 211 and 212 are illustrated to be upwardly offset by an angle β as shown, wherein the angle β is measured from the plane defined by the bottom surface 218 of washer 210A to the bottom face of tab 211 or 212. In accordance with aspects of the present disclosure, the angle β may range from about 1° to about 60°, more preferably from about 5° to about 50°. Suitable values for the offset angle β described herein include, but are not limited to, about 5°, about 10°, about 15°, about 20°, about 25°, about 30°, about 35°, about 40°, about 45°, about 50°, about 55°, and about 60°, as well as values falling within any two values in this range, e.g., from about 15° to about 45°. In accordance with one aspect of the present disclosure, the tabs 211 and 212 are upwardly offset by an angle β of about 30°. The inclusion of the offset for tabs 211 and 212 is that in some instances, during installation, it becomes necessary to raise the tabs in order to insert the female connector onto the tab. With the inclusion of the upward offset of the tabs, the connector may be inserted with no preliminary adjustment of the tabs on the washer being necessary. Regardless of the angle β selected, in accordance with an aspect of the present disclosure, the angle β is selected so as to produce as low a profile as possible, in order to give the wiring itself a low profile.

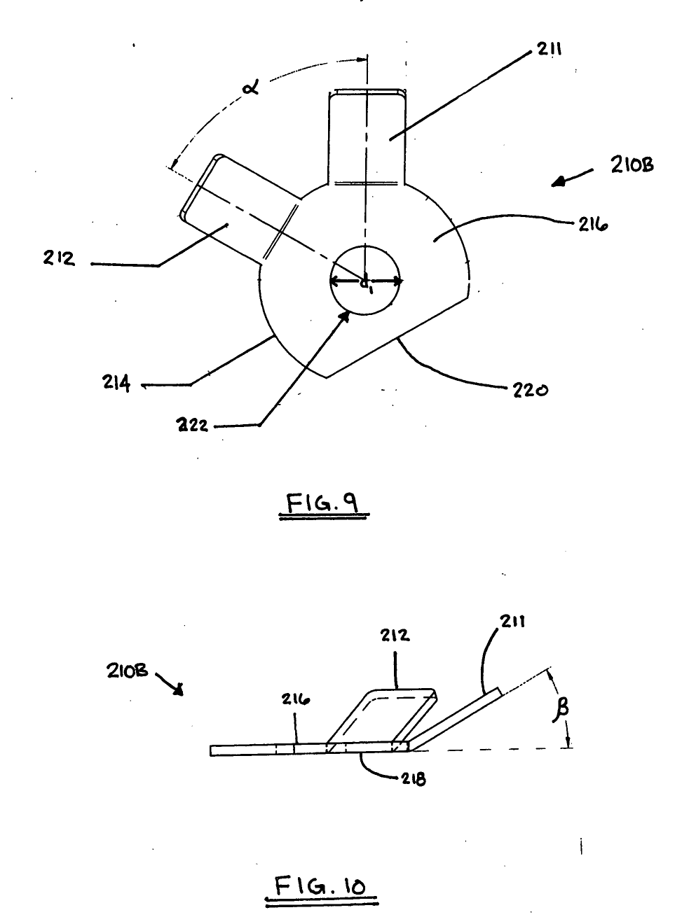

FIGS. 9 and 10 illustrate a quick-connect washer 210B in accordance with yet another aspect of the present disclosure, wherein a portion of the outer periphery of the washer 210B defines a flat side 220 generally opposite the tabs 211 and 212, and perpendicular to the top surface 216 of the washer. The flat side 220 may be included to help prevent the quick-connect washer 210B from rotating about the terminal bolt 32, thereby keeping the tabs 211 and 212 in the desired position for attachment of the monitor cables. Similar to the aspect shown in FIG. 7, tabs 211 and 212 are oriented at an angle α relative to each other, the angle α ranging from about 5° to about 180°, more preferably from about 5° to about 120°, and even more preferably from about 10° to about 60°. In the side profile illustrated in FIG. 10, it can be seen that tabs 211 and 212 are also upwardly offset by an angle β, the angle β having been described above in accordance with the aspect of FIGS. 7 and 8. In accordance with one preferred aspect of the present disclosure, the quick-connect washer 210B comprises a flat side 220 and two tabs 211 and 212, the tabs having an orientation angle α of about 30°, and an upward offset angle β of about 30°.

The embodiments shown in FIGS. 5-10 include a circular central opening 122 having a diameter d₁ through which the terminal bolt 32 extends. Diameter d₁ of opening 122 may be of any appropriate distance, and will depend largely upon the diameter of the terminal bolt 32 or other suitable protrusion that is to extend therethrough. For example, in accordance with an aspect of the present disclosure, and without limitation, central opening 122 has a diameter d₁ that is at least ½ of the outer diameter d₂ of the quick-connect washer itself, regardless of the exterior shape of the washer.

The quick connect washers 110 and 210 as described herein can be manufactured from a number of appropriate materials. For example, in accordance with one aspect of the present disclosure, stainless steel is a suitable material for the quick connect washer 110 in battery applications, although any appropriate material may be used in the manufacture of quick-connect washers 110 and 210. Such suitable materials include but are not limited to steel; aluminum; brass; bronze; copper; molybdenum; tungsten; titanium; zinc; alloys; plastics, such as PVC (polyvinyl chloride); and materials which comprise one or more of the transition metal elements in the Periodic Table of Elements. Additionally, in accordance with further aspects of the present disclosure, the quick-connect washers 110 and 210 described herein may be coated with any desirable, and appropriate, coating material, such as those materials useful in preventing corrosion and extending the life of the quick-connect washer.

In accordance with further aspects of the present disclosure, while the washers 110A, 110B, 210A and 210B have been generally illustrated as having an annular (circular) periphery, or optionally an annular periphery comprising a flat side 120, those of skill in the art will realize that the quick-connect washers described herein may have a periphery of any desired geometric shape, including but not limited to square, hexagonal, trigonal, heptagonal, octagonal, and the like. In one aspect of the present disclosure, the quick-connect washers of the present disclosure preferably have a hexagonal shaped periphery. Similarly, the quick-connect washers of the present disclosure have been described to have two tabs extending from the periphery of the washer. However, it is envisioned that the washers described herein could have more than two tabs extending from the periphery of the washers, the tabs being oriented spatially as appropriate.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intends to protect all such modifications and improvements to the full extent that such falls within the scope or range of equivalent of the following claims.

What is claimed is:

1. A battery connection system, comprising:
a quick connect washer defining a central opening therethrough and having first and second tabs extending from an outer periphery thereof for attaching to terminal ends of monitor cables; and
a fastening device extending through the central opening for fastening the quick connect washer to a battery terminal.

2. The battery connection system of claim 1, further comprising an interconnect cable having a terminal end, the fastening device extending through an opening in the terminal end of the interconnect cable for fastening the interconnect cable to the battery terminal.

3. The battery connection system of claim 1, further comprising a flat washer.

4. The battery connection system of claim 1, further comprising a lock washer.

5. The battery connection system of claim 1, wherein the fastening device includes a bolt extending from the battery terminal and through the tab washer with a nut threaded onto the bolt to fasten the tab washer to the battery terminal.

6. The battery connection system of claim 1, wherein the fastening device includes a terminal bolt having a threaded end received in a threaded opening in the battery terminal.

7. The battery connection system of claim 1, wherein the first and second tabs on the outer periphery of the washer are disposed to each other at an angle ranging from about 5° to about 180°.

8. The battery connections system of claim 7, wherein the first and second tabs on the outer periphery of the washer are disposed to each other at an angle of about 60°.

9. The battery connection system of claim 1, wherein the first and second tabs are bent at an angle away from the plane of the washer, the angle of bend ranging from about 5° to about 75°.

10. The battery connection system of claim 9, wherein the first and second tabs are bent at an angle away from the plane of the washer at an angle of about 30°.

11. The battery connection system of claim 1, wherein the quick connect washer comprises a flat side generally opposite the first and second tabs on the periphery of the washer.

12. The battery connection system of claim of claim 11 wherein the first and second tabs on the outer periphery of the washer are disposed to each other at an angle ranging from about 5° to about 180°.

13. The battery connection system of claim 12, wherein the first and second tabs are disposed to each other at an angle of about 60°.

14. The battery connection system of claim 11, wherein the first and second tabs are bent at an angle away from the plane of the washer, the angle of bend ranging from about 5° to about 75°.

15. The battery connection system of claim 14, wherein the first and second tabs are bent at an angle away from the plane of the washer at an angle of about 30°.

16. A method of connecting a battery monitoring system to a battery terminal, comprising the steps of:
fastening a quick connect washer having first and second tabs extending from an outer periphery thereof to a battery terminal; and
connecting first and second cables of the battery monitoring system to the first and second tabs, respectively.

17. The method of claim 16, wherein fastening the quick connect washer to the battery terminal includes extending a terminal bolt through a central opening of the quick connect washer and fastening the terminal bolt to the battery terminal.

18. The method of claim 17, wherein fastening the quick connect washer to the battery terminal includes extending the terminal bolt through a flat washer.

19. The method of claim 17, wherein fastening the quick connect washer to the battery terminal includes extending the terminal bolt through a lock washer.

20. The method of claim 17, wherein fastening the quick connect washer to the battery terminal includes threading a nut onto the terminal bolt.

21. The method of claim 17, wherein fastening the quick connect washer to the battery terminal includes threading the terminal bolt into a threaded opening in the battery terminal.
